(19) United States
(12) Patent Application Publication
(10) Pub. No.: US 2011/0024024 A1
(43) Pub. Date: Feb. 3, 2011

(54) METHOD OF FABRICATING SUPER FINISHED ITB'S VIA INTERNAL MANDREL FLOW COATING

(75) Inventors: Dante M. PIETRANTONI, Rochester, NY (US); Robert ALTAVELA, Webster, NY (US); Jin WU, Webster, NY (US); Jonathan Henry HERKO, Walworth, NY (US); Scott Joseph GRIFFIN, Fairport, NY (US); Michael S. ROETKER, Webster, NY (US)

Correspondence Address: MH2 TECHNOLOGY LAW GROUP, LLP (CUST. NO. W/XEROX), 1951 KIDWELL DRIVE, SUITE 550, TYSONS CORNER, VA, 22182, US

(73) Assignee: XEROX CORPORATION, Norwalk, CT (US)

(21) Appl. No.: 12/534,270

(22) Filed: Aug. 3, 2009

(51) Int. Cl. F16G 1/16

(52) U.S. Cl. 156/137; 425/49

(57) ABSTRACT

Provided are apparatuses and methods of making a transfer belt. The method can include providing a hollow mandrel including an interior surface and rotating about a longitudinal axis. The method can also include dispensing a coating liquid through a dispensing tip over the interior surface of the rotating mandrel and using a doctor blade to smooth the coating liquid to form a layer of coating. The method can further include curing the layer of coating to form a seamless belt over the interior surface of the mandrel and releasing the belt from the interior surface of the mandrel, wherein the belt has a thickness uniformity in the range of about 100 nm to about 1 um.

### DETAILED DESCRIPTION

1. Field of Use

The present teachings relate to electrostatography and electrophotography and, more particularly, to methods of making a transfer belt for fuser xerographic applications.

2. Background

Intermediate transfer belts (ITBs) are commonly used in the image forming apparatuses, especially in those employing multi-color processing to increase productivity Currently, most ITB's in use have a seam where the two ends of the ITB are joined together to form a circular belt. The seam, either ultrasonically welded or joined in some other fashion, has been a source of many problems from toner accumulation to early cleaning blade wear. Furthermore, due to the inability to form a defect free image at the seam, this portion of the belt has to be avoided, thereby making seam detection a complex technological issue. A seamless belt would eliminate the need to avoid the seam area and the associated problems mentioned above. Various methods of coating the exterior of a mandrel to form a seamless belt, such as flow coating, ring coating or dip coating, provide many challenges to obtaining a smooth surface, high gloss, and uniform thickness.

Accordingly, there is a need to overcome these and other problems of prior art to provide a new method to form seamless belt.

### SUMMARY

In accordance with various embodiments, there is a method of making a transfer belt, the method including providing a hollow mandrel rotating about a longitudinal axis, the mandrel including an interior surface. The method can also include dispensing a coating liquid through a dispensing tip over the interior surface of the rotating mandrel and using a doctor blade to smooth the coating liquid to form a layer of coating, such that the layer of coating has a uniform thickness over the interior surface of the mandrel. The method can further include curing the layer of coating to form a seamless belt over the interior surface of the mandrel and releasing the belt from the interior surface of the mandrel, wherein the belt has a thickness uniformity in the range of about 100 nm to about 1 um.

In accordance with various embodiments, there is an apparatus for forming a seamless transfer belt. The apparatus can include a hollow mandrel rotating about a longitudinal axis, the mandrel including an interior surface. The apparatus can also include a dispensing tip disposed on an arm, the dispensing tip connected to a liquid reservoir and a doctor blade disposed adjacent to the dispensing tip, wherein one or more of the dispensing tip and the hollow mandrel are moveable in one or more of x, y, and z direction.

Additional advantages of the embodiments will be set forth in part in the description which follows, and in part will be obvious from the description, or may be learned by practice of the present teachings. The advantages will be realized and attained by means of the elements and combinations particularly pointed out in the appended claims.

It is to be understood that both the foregoing general description and the following detailed description are exemplary and explanatory only and are not restrictive of the present teachings, as claimed.

The accompanying drawings, which are incorporated in and constitute a part of this specification, illustrate embodiments of the present teachings and together with the description, serve to explain the principles of the present teachings.

### BRIEF DESCRIPTION OF THE DRAWINGS

FIG. 1 shows an exemplary method of making a transfer belt, according to various embodiments of the present teachings.

FIG. 2 schematically illustrates an exemplary apparatus for forming a transfer belt, in accordance with various embodiments of the present teachings.

FIG. 3 schematically illustrates another exemplary apparatus for forming a transfer belt, in accordance with various embodiments of the present teachings.

FIGS. 4A-4C schematically illustrates exemplary transfer belts, according to various embodiments of the present teachings.

### DESCRIPTION OF THE EMBODIMENTS

Reference will now be made in detail to the present embodiments, examples of which are illustrated in the accompanying drawings. Wherever possible, the same reference numbers will be used throughout the drawings to refer to the same or like parts.

Notwithstanding that the numerical ranges and parameters setting forth the broad scope of the present teachings are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less that 10” can assume negative values, e.g. −1, −2, −3, −10, −20, −30, etc.

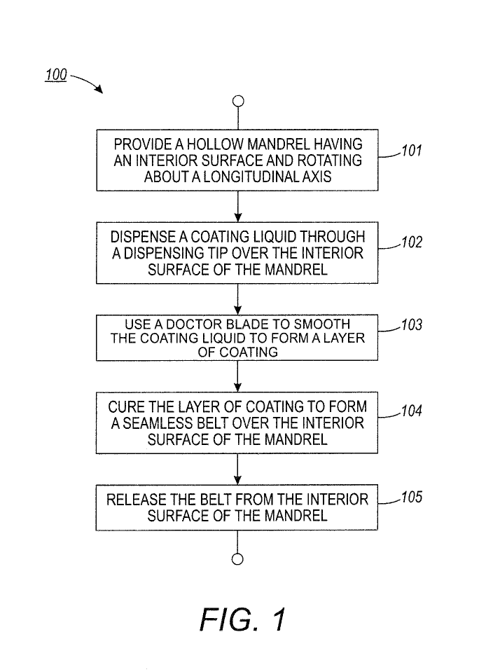

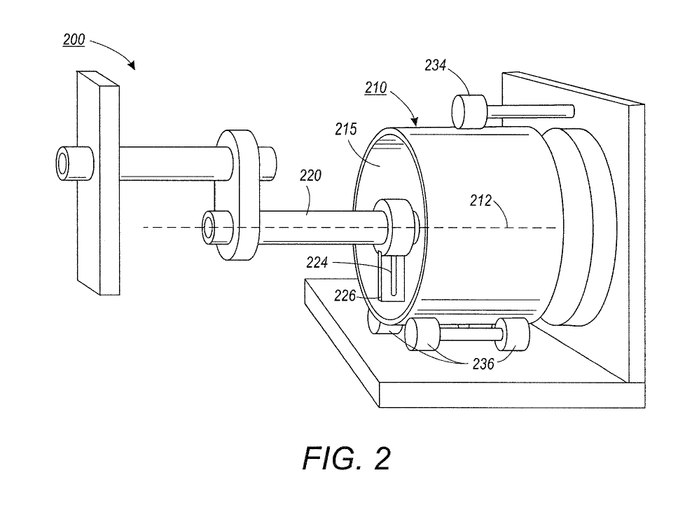

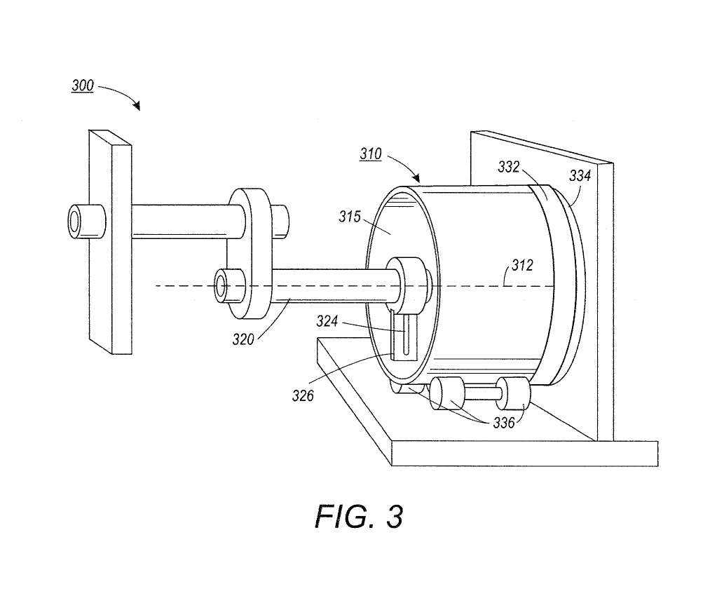

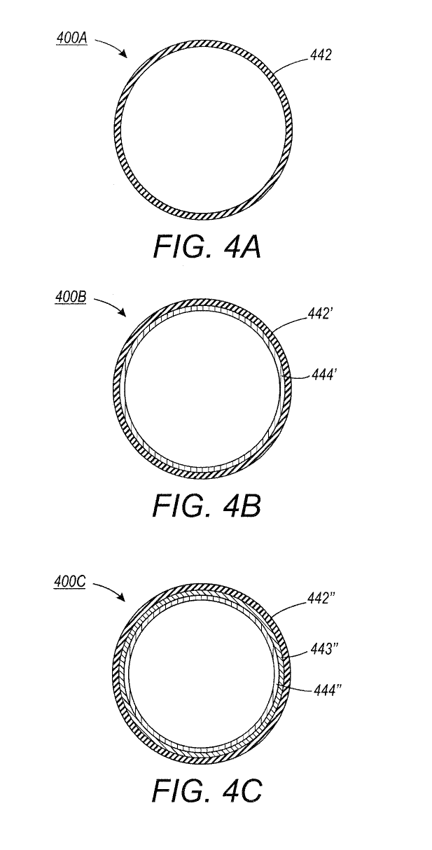

FIG. 1 shows an exemplary method 100 of making an exemplary transfer belt, for example, transfer belts 400A, 400B, 400C shown in FIGS. 4A-4C, according to various embodiments of the present teachings. The method 100 of making the transfer belts 400A, 400B, 400C can include a step 101 of providing a hollow mandrel rotating about a longitudinal axis, for example, exemplary hollow mandrel 210, 310 shown in FIGS. 2 and 3. FIGS. 2 and 3 schematically illustrate exemplary apparatus 200, 300 for forming seamless transfer belts, for example,exemplary seamless transfer belts 400A, 400B, 400C shown in FIGS. 4A-4C. The apparatus 200, 300 can include a hollow mandrel 210, 310 rotating about a longitudinal axis 212, 312. The mandrel 210, 310 can include an interior surface 215, 315. In various embodiments, the interior surface 215, 315 of the mandrel 210, 310 can have a surface treatment to prepare the interior surface 215, 315 to have a roughness in the range of about 100 nm to about 1 um and in some cases greater than about 1 um if patterning is required for some applications. In some embodiments, the mandrel 210 can be disposed between a drive wheel 234 and a plurality of rolling members 236, such that the mandrel 210 can be rotated by the drive wheel 234, as shown in FIG. 2. In other embodiments, the mandrel 310 can be disposed over a plurality of rolling members 336 and can be coupled to a drive motor 334 via one or more of a drive belt 332 and a coupling, as shown in FIG. 3. In some cases, the mandrel 210, 310 can rotate to produce a surface speed of about 1 mm/sec to 300 mm/sec and in other cases of about 50 mm/sec to 200 mm/sec. In some other cases, the mandrel 210, 310 can rotate to produce a surface speed of greater than about 200 mm/sec. In various embodiments, the mandrel 210, 310 can be rotated at any suitable speed, such as, for example, 1 rpm to about 50 rpm. One of ordinary skill in the art would know that the rotational speed of the mandrel is dependent upon various factors, including, but not limited to, fluid, thermodynamic and material properties of the coating liquid. In some embodiments, the hollow mandrel 210, 310 can include a rigid drum. In other embodiments, the hollow mandrel 210, 310 can include a flexible belt.

The apparatus 200, 300 can also include a dispensing tip 224, 324 disposed on an arm 220, 320. The dispensing tip 224, 324 can also include a nozzle, a needle, a die, or any other suitable dispensing device. As used herein, the term “die” refers to a dispensing tip 224, 324 that can be as long as the width of the mandrel 210, 310 and it dispenses the coating liquid along the width of the mandrel 210, 310 at once. The dispensing tip 224, 324 can be connected to a coating liquid reservoir, such that the coating liquid can be supplied to the dispensing tip via pipes hooked up to a pump or a pressurized vessel. The apparatus 200, 300 can also include a doctor blade 226, 326 disposed adjacent to the dispensing tip 224, 324. As used herein, the term “doctor blade” refers to a blade, a scraper, a metal or a plastic strip, or any other device that can be used for spreading, smoothing, and/or regulating the amount of liquid and or paste material on the mandrel. The type of doctor blade and the material that the doctor blade is made of is dependent upon the physical, fluid, and thermodynamic properties of the coating liquid including additives and solvent system of the coating liquid. In some embodiments, the doctor blade 226, 326 can be disposed on the arm 220, 320. In other embodiments, the doctor blade 226, 326 can be disposed separately. In various embodiments, one or more of the dispensing tip 224, 334, the doctor blade, 226, 326 and the hollow mandrel 210, 310 can be moved in one or more of x, y, and z direction. In some cases, the mandrel 210, 310 can be stationary while the dispensing tip 224, 334 is moveable; in other cases, the dispensing tip 224, 334 can be stationary while the mandrel 210, 310 is moveable; and so on. The dispensing tip 224, 324 and the doctor blade via the arm 220, 320 can traverse along the longitudinal axis 212, 312 at a speed predetermined by the rotational or surface velocity of the mandrel; fluid, thermodynamic, and material properties of the coating liquid; dimensions of the dispensing needle; and material, configuration, and dimensions of the doctor blade. In certain embodiments, the dispensing tip 224, 324 and the doctor blade via the arm 220, 320 can traverse along the longitudinal axis 212, 312 at a speed in the range from about 0.1 mm/sec to about 1000 mm/sec. In various embodiments, where the dispensing tip 224, 324 can be a die, the dispensing tip 224, 324 can remain stationary.

Referring back to FIG. 1, the method 100 of making transfer belts 400A, 400B, 400C can also include a step 102 of dispensing a coating liquid through a dispensing tip 224, 324 over the interior surface 215, 315 of the rotating mandrel 210, 310. In some embodiments, the step 102 of dispensing a coating liquid through a dispensing tip 224, 324 can also include by moving one or more of the dispensing tip 224, 324 and the mandrel 210, 310 along the longitudinal axis 212, 312 of the mandrel 210, 310. In other embodiments, the dispensing tip 224, 324 can remain stationary when the dispensing tip 224, 324 can be a die. The method 100 can also include a step 103 of using a doctor blade 226, 326 to smooth the coating liquid to form a layer of coating, such that the layer of coating can have a uniform thickness over the interior surface 215, 315 of the mandrel 210, 310. In various embodiments, the mandrel 210, 310 can continue to rotate after the formation of the layer of coating for an optimized amount of time to avoid coating material sag, and allow for solvent in the coating liquid to flash off. In various embodiments, it is the doctor blade 226, 326 and and/or gravity that spreads the coating liquid to form the layer of coating without use of a centrifugal force generated by the rotation of the mandrel 210, 310. In some embodiments, the step 102 of dispensing a coating liquid can include dispensing a solution of one or more of a polyimide, a polycarbonate, a polyamideimide, a polyphenylene sulfide, a polyamide, a polysulfone, a polyetherimide, a polyester, a polyvinylidene fluoride, a polyethylene-co-polytetrafluoroethylene, and an acrylate polymer, oligomers or monomers.

In some embodiments, the exemplary polyimide can include, but is not limited to low temperature and rapidly cured polyimide polymers, such as VTEC™ PI 1388, 080-051, 851, 302, 203, 201, and PETI-5, all available from Richard Blaine International, Incorporated (Reading, Pa.). These low temperature thermosetting polyimides can be cured at a temperature in the range of about 180° C. to about 260° C. for about 10 minutes to about 120 minutes and in some cases from about 20 minutes to about 60 minutes. These low temperature thermosetting polyimides can have a number average molecular weight (Mₙ) in the range of about 5,000 to about 500,000 and in some cases from about 10,000 to about 100,000; and a weight average molecular weight (M_{w}) in the range of about 50,000 to about 5,000,000 and in some cases from about 100,000 to about 1,000,000. In other embodiments, the exemplary polyimide can include other thermosetling polyimides that can be cured at a temperature of above about 300° C., such as, for example, PYRE ML® RC-5019, RC 5057, RC-5069, RC-5097, RC-5053, and RK-692, all commercially available from Industrial Summit Technology Corporation (Parlin, N.J.); RP-46 and RP-50, both commercially available from Unitech LLC (Hampton, Va.); DURIMIDE® 100 commercially available from FUJIFILM Electronic Materials U.S.A., Inc. (North Kingstown, R.I.); and KAPTON® HN, VN and FN, all commercially available from E.I. DuPont (Wilmington, Del.).

In various embodiments, the exemplary polyamideimides can be synthesized by at least the following two methods (1) isocyanate method which involves the reaction between isocyanate and trimellitic anhydride; or (2) acid chloride method where there is reacted a diamine and trimellitic anhydride chloride. Examples of these polyamideimides include VYLOMAX® HR-11NN (15 weight % solution in N methylpyrrolidone; T_{g} of about 300° C.; and M_{w} of about 45,000), HR-12N2 (30 weight % solution in N-methylpyrrolidone/xylene/methyl ethyl ketone (50/35/15); T_{g} of about 255° C.; and M_{w} of about 8,000); HR-13NX (30 weight % solution in N-methylpyrrolidone/xylene (67/33); T_{g} of about 280° C.; and M_{w} of about 10,000), HR-15ET (25 weight % solution in ethanol/toluene (50/50); T_{g} of about 260° C.; and M_{w} of about 10,000), HR-16NN (14 weight % solution in N-methylpyrrolidone; T_{g} of about 320° C.; and M_{w} of about 100,000), all commercially available from Toyobo Company (Osaka, Japan); and TORLON® AI-10 (T_{g} of about 272° C.), commercially available from Solvay Advanced Polymers, LLC (Alpharefta, Ga.).

In various embodiments, the coating liquid can also include one or more additives including, but not limited to, carbon black, carbon nanotubes, metal oxide, and polyaniline.

Carbon black can be present in any suitable amount in the coating liquid, such that the transfer belts 400A, 400B, 400C can have carbon black in an amount from about 1 weight % to about 30 weight %, in some cases from about 5 weight % to about 25 weight %, and in some other cases from about 10 weight % to about 20 weight %. The conductivity of carbon black is dependent on surface area and its structure primarily. Generally, the higher the surface area and the higher the structure, the more conductive is the carbon black. Surface area is measured by the B.E.T. nitrogen surface area per unit weight of carbon black, and is the measurement of the primary particle size. Structure is a complex property that refers to the morphology of the primary aggregates of carbon black. It is a measure of both the number of primary particles comprising primary aggregates, and the manner in which they are “fused” together. High structure carbon blacks are characterized by aggregates comprised of many primary particles with considerable “branching” and “chaining”, while low structure carbon blacks are characterized by compact aggregates comprised of fewer primary particles. Structure is measured by dibutyl phthalate (DBP) absorption by the voids within carbon blacks. The higher the structure, the more the voids, and the higher the DBP absorption.

Examples of carbon blacks selected for the ITB include, but are not limited to, VULCAN® carbon blacks, REGAL® carbon blacks, MONARCH® carbon blacks and BLACK PEARLS® carbon blacks available from Cabot Corporation (Boston, Mass.). Specific examples of conductive carbon blacks are BLACK PEARLS® 1000 (B.E.T. surface area=343 m²/g, DBP absorption=1.05 ml/g), BLACK PEARLS® 880 (B.E.T. surface area=240 m²/g, DBP absorption=1.06 ml/g), BLACK PEARLS® 800 (B.E.T. surface area=230 m²/g, DBP absorption=0.68 ml/g), BLACK PEARLS® L (B.E.T. surface area=138 m²/g, DBP absorption=0.61 ml/g), BLACK PEARLS® 570 (B.E.T. surface area=110 m²/g, DBP absorption=1.14 ml/g), BLACK PEARLS® 170 (B.E.T. surface area=35 m²/g, DBP absorption=1.22 ml/g), VULCAN® XC72 (B.E.T. surface area=254 m²/g, DBP absorption=1.76 ml/g), VULCAN® XC72R (fluffy form of VULCAN® XC72), VULCAN® XC605, VULCAN® XC305, REGAL® 660 (B.E.T. surface area=112 m²/g, DBP absorption=0.59 ml/g), REGAL® 400 (B.E.T. surface area=96 m²/g, DBP absorption=0.69 ml/g), REGAL® 330 (B.E.T. surface area=94 m²/g, DBP absorption=0.71 ml/g), MONARCH® 880 (B.E.T. surface area=220 m²/g, DBP absorption=1.05 ml/g, primary particle diameter=16 nanometers), and MONARCH® 1000 (B.E.T. surface area=343 m²/g, DBP absorption=1.05 ml/g, primary particle diameter=16 nanometers); Channel carbon blacks available from Evonik-Degussa (Essen, Germany) include: Special Black 4 (B.E.T. surface area=180 m²/g, DBP absorption=1.8 ml/g, primary particle diameter=25 nanometers), Special Black 5 (B.E.T. surface area=240 m²/g, DBP absorption=1.41 ml/g, primary particle diameter=20 nanometers), Color Black FW1 (B.E.T. surface area=320 m²/g, DBP absorption=2.89 ml/g, primary particle diameter=13 nanometers), Color Black FW2 (B.E.T. surface area=460 m²/g, DBP absorption=4.82 ml/g, primary particle diameter=13 nanometers), and Color Black FW200 (B.E.T. surface area=460 m²/g, DBP absorption=4.6 ml/g, primary particle diameter=13 nanometers).

The method 100 of making an intermediate transfer belt 400A, 400B, 400C can further include a step 104 of curing the layer of coating to form a seamless belt 400A, 400B, 400C over the interior surface 215, 315 of the mandrel 210, 310 and a step 105 of releasing the belt 400A, 400B, 400C from the interior surface 215, 315 of the mandrel 210, 310. Any suitable curing method can be used to cure the coating liquid to form a seamless belt including, but not limited to, thermal curing, uv curing, e-beam curing, oxidative curing, and epoxy curing. In some embodiments, additional curing of the belt can be done separately in a specially designed curing device, such as an oven. In various embodiments, the belt 400A, 400B, 400C can have a thickness uniformity in the range of about 100 nm to about 1 um and in some cases greater than about 1 um if special patterning is required for certain applications. The belt 400A, 400B, 400C can be released from the interior surface 215, 315 of the mandrel 210, 310 using any suitable technique. In some embodiments, the belt 400A, 400B, 400C can be released using one or more of surfactants, coating process, coating thickness, releasing agents, solvents, and difference in thermal expansion of the belt and the mandrel. Exemplary solvents that can be used to release the belt can include, but are limited to, water, alcohols, N,N-diemthylforamide, diglyme, N,N-dimethylacetamide, N-methylpyrrolidone, dimethylsulfoxide and the like. In some embodiments, the belt 400A, 400B, 400C can be released using difference in thermal expansion of the belt 400A, 400B, 400C and the mandrel 210, 310 by either heating or cooling the mandrel 210, 310. In some other embodiments, a releasing agent can be applied over the interior surface 215, 315 of the mandrel 210, 310 before the step 102 of dispensing the coating liquid through the dispensing tip 224, 324 over the interior surface 215, 315 of the rotating mandrel 210, 310. Any suitable releasing agents can be used, including, but not limited to, TEFLON®-like materials such as, for example, fluorinated ethylene propylene copolymer (FEP), polytetrafluoroethylene (PTFE), polyfluoroalkoxy polytetrafluoroethylene (PFA TEFLON®); silicone materials such as, for example, fluorosilicones; and silicone rubbers such as, for example, silicone rubber 552, available from Sampson Coatings (Richmond, Va.), polydimethyl siloxaneldibutyl tin diacetate (DBTDA) and polydimethyl siloxane rubber mixture; and fluoroelastomers such as, for example, copolymers and terpolymers of vinylidenefluoride, hexafluoropropylene, and tetrafluoroethylene, which are known commercially under various designations as VITON A®, VITON E®, VITON E60C®, VITON E45®, VITON E430®, VITON B910°, VITON GH®, VITON B50, VITON E45®, and VITON GF® available from E.I. DuPont de Nemours, Inc. (Wilmington, Del.). Some of the fluoroelastomers can include a cure site monomer into their polymer chains in order to crosslink efficiently, including, but not limited to, a class of tetrapolymers of vinylidenefluoride, hexafluoropropylene, tetrafluoroethylene, and a cure site monomer, such as, for example, VITON GF®, having 35 mole percent of vinylidenefluoride, 34 mole percent of hexafluoropropylene, and 29 mole percent of tetrafluoroethylene with 2 percent cure site monomer. Exemplary cure site monomer can include, but is not limited to, 4-bromoperfluorobutene-1,1,1-dihydro-4-bromoperfluorobutene-1,3-bromoperfluoropropene-1,1,1-dihydro-3-bromoperfluoropropene-1, and the like.

In some embodiments, the method 100 of making a transfer belt 400A, 400B, 400C can include forming one or more additional layers of coating over the layer of coating. One or more additional layers of coating can be formed by first dispensing a second coating liquid through the dispensing tip 224, 324 over the layer of coating and using a doctor blade 224, 324 to smooth the second coating liquid to form a second layer of coating over the layer of coating, such that the second layer of coating can have a uniform thickness. In some embodiments, the step of dispensing a second coating liquid through the dispensing tip 224, 324 over the layer of coating can include moving at least one of the dispensing tip 224,324 and the mandrel 224, 324 along the longitudinal axis 212, 312 of the mandrel 210, 310 In other embodiments, when the dispensing tip 224, 324 can be a die, the dispensing tip 224, 324 can remain stationary while dispensing second coating liquid through the dispensing tip 224, 324 over the layer of coating. The second layer of coating can be partially cured if a third layer of coating is desired and the steps of dispensing the coating liquid, smoothing the coating liquid, and curing can be repeated. After the formation of desired number of additional layers of coating, the method 100 can then include curing the multiple layers of coating to form a seamless belt 400A, 400B, 400C over the interior surface 215, 315 of the mandrel 210, 310 and a step 105 of releasing the belt 400A, 400B, 400C from the interior surface 215, 315 of the mandrel 210, 310. In some embodiments, the formation of additional layers of the coating can include dispensing the same coating liquid for each layer of coating, such that the first layer of coating is the same as the second layer of coating in terms of material composition, thereby resulting in a single layer belt 400A as shown in FIG. 4A. In other embodiments, the formation of additional layers of the coating can include dispensing one or more coating liquids, such that the first coating is different from the second coating in terms of material composition and/or thickness, thereby resulting in a two layer belt 400B as shown in FIG. 4B. FIG. 4B schematically illustrates an exemplary belt 400B including a first layer 442′ and a second layer 444′ disposed over the first layer 442′. The first layer 442′ can be formed after full or partial curing of the first layer of coating over the interior surface 215, 315 of the rotating mandrel 210, 310 and the second layer 444′ can be formed after curing the second layer of coating over the first layer of coating. In various embodiments, the first layer 442′ can include any suitable material such as, for example, polyimides, polyetherimides, polyamideimides, acrylics and their mixtures. In other embodiments, the second layer 444′ can include any suitable material, including, but not limited to, polyimides, polyetherimides, polyamideimides, acrylics, aminoplasts, polyamides, polysulfones, polyphenylene sulfides, PVDF, polyesters, or polystyrene polyacrylonitrile polybutadiene terpolymers, and their mixtures. FIG. 4C shows another exemplary embodiment of a belt 400C having three layers different from each other in composition. In some embodiments, the first layer 442″ can include any suitable material such as, example, polyimides, polyetherimides, polyamideimides, or acrylics and their mixtures. In other embodiments, the second layer 444″ can include any suitable material, including, but not limited to, polyimides, polyetherimides, polyamideimides, acrylics, aminoplasts, polyamides, polysulfones, polyphenylene sulfides, PVDF, polyesters, or polystyrene polyacrylonitrile polybutadiene terpolymers, and their mixtures. In some other embodiments, the third layer 446″ can include any suitable material, including, but not limited to, TEFLON®-like materials such as, for example, fluorinated ethylene propylene copolymer (FEP), polytetrafluoroethylene (PTFE), polyfluoroalkoxy polytetrafluoroethylene (PFA TEFLON®); silicone materials such as, for example, fluorosilicones; and silicone rubbers such as, for example, silicone rubber 552, available from Sampson Coatings (Richmond, Va.), polydimethyl siloxane/dibutyl tin diacetate (DBTDA) and polydimethyl siloxane rubber mixture; and fluoroelastomers such as, for example, copolymers and terpolymers of vinylidenefluoride, hexafluoropropylene, and tetrafluoroethylene, which are known commercially under various designations as VITON A®, VITON E®, VITON E60C®, VITON E45®, VITON E430®, VITON B910®, VITON GH®, VITON B50®, VITON E45®, and VITON GF® available from E.I. DuPont de Nemours, Inc. (Wilmington, Del.). Some of the fluoroelastomers can include a cure site monomer into their polymer chains in order to crosslink efficiently, including, but not limited to, a class of tetrapolymers of vinylidenefluoride, hexafluoropropylene, tetrafluoroethylene, and a cure site monomer, such as, for example, VITON GF®, having 35 mole percent of vinylidenefluoride, 34 mole percent of hexafluoropropylene, and 29 mole percent of tetrafluoroethylene with 2 percent cure site monomer. Exemplary cure site monomer can include, but is not limited to, 4-bromoperfluorobutene-1,1,1-dihydro-4-bromoperfluorobutene-1,3-bromoperfluoropropene-1,1,1-dihydro-3-bromoperfluoropropene-1, and the like.

In various embodiments, the method 100 of making a transfer belt 400A, 4008, 400C can also include preparing the interior surface 215, 315 of the mandrel 210, 310 before the step 102 of dispensing the coating liquid. In some embodiments, the step of preparing the interior surface 215, 315 of the mandrel 210, 310 can include modifying the interior surface 215, 315 of the mandrel 210, 310 to a predetermined surface roughness in the range of about 100 nm to about 1 um and in some cases greater than about 1 um if special patterning is required for certain applications. In certain embodiments, the step of preparing the interior surface 215, 315 of the mandrel 210, 310 can include applying a layer of releasing agent over the interior surface 215, 315 of the mandrel 210, 310. Any suitable releasing agents can be used, including, but not limited to, TEFLON®-like materials such as, for example, fluorinated ethylene propylene copolymer (FEP), polytetrafluoroethylene (PTFE), polyfluoroalkoxy polytetrafluoroethylene (PFA TEFLON®); silicone materials such as, for example, fluorosilicones; and silicone rubbers such as, for example, silicone rubber 552, available from Sampson Coatings (Richmond, Va.), polydimethyl siloxaneldibutyl tin diacetate (DBTDA) and polydimethyl siloxane rubber mixture; and fluoroelastomers such as, for example, copolymers and terpolymers of vinylidenefluoride, hexafluoropropylene, and tetrafluoroethylene, which are known commercially under various designations as VITON A®, VITON E®, VITON E60C®, VITON E45®, VITON E430®, VITON B910®, VITON GH®, VITON B50®, VITON E45®, and VITON GF® available from E.I. DuPont de Nemours, Inc. (Wilmington, Del.). Some of the fluoroelastomers can include a cure site monomer into their polymer chains in order to crosslink efficiently, including, but not limited to, a class of tetrapolymers of vinylidenefluoride, hexafluoropropylene, tetrafluoroethylene, and a cure site monomer, such as, for example, VITON GF®, having 35 mole percent of vinylidenefluoride, 34 mole percent of hexafluoropropylene, and 29 mole percent of tetrafluoroethylene with 2 percent cure site monomer. Exemplary cure site monomer can include, but is not limited to, 4-bromoperfluorobutene-1,1,1-dihydro-4-bromoperfluorobutene-1,3-bromoperfluoropropene-1,1,1-dihydro-3-bromoperfluoropropene-1, and the like,

In various embodiments, properties of the transfer belt 400A, 400B, 400C such as thickness and thickness uniformity of each layer can be controlled by various interdependent material and coating process parameters including, but not limited to, additives and surfactants present in the coating liquid, amount of solid present and solvent properties of the coating liquid; viscosity of the coating liquid; flow rate of the dispensed coating liquid; material, configuration, and dimensions of the doctor blade; speed of the dispensing tip along the longitudinal axis; and rotational or surface speed of the mandrel.

While the present teachings has been illustrated with respect to one or more implementations, alterations and/or modifications can be made to the illustrated examples without departing from the spirit and scope of the appended claims. In addition, while a particular feature of the present teachings may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.” As used herein, the phrase “one or more of”, for example, A, B, and C means any of the following: either A, B, or C alone; or combinations of two, such as A and B, B and C, and A and C; or combinations of three A, B and C.

Other embodiments of the present teachings will be apparent to those skilled in the art from consideration of the specification and practice of the present teachings disclosed herein. It is intended that the specification and examples be considered as exemplary only, with a true scope and spirit of the present teachings being indicated by the following claims.

What is claimed is:

1. A method of making a transfer belt, the method comprising:
providing a hollow mandrel rotating about a longitudinal axis, the mandrel comprising an interior surface;
dispensing a coating liquid through a dispensing tip over the interior surface of the rotating mandrel;
using a doctor blade to smooth the coating liquid to form a layer of coating, such that the layer of coating has a uniform thickness over the interior surface of the mandrel;
curing the layer of coating to form a seamless belt over the interior surface of the mandrel; and
releasing the belt from the interior surface of the mandrel, wherein the belt has a thickness uniformity in the range of about 100 nm to about 1 um.

2. The method of making a transfer belt according to claim 1, wherein the step of dispensing a coating liquid comprises dispensing a solution of one or more of a polyimide, a polycarbonate, a polyamideimide, a polyphenylene sulfide, a polyamide, a polysulfone, a polyetherimide, a polyester, a polyvinylidene fluoride, a polyethylene-co-polytetrafluoroethylene, an acrylate polymers, oligomers or monomers.

3. The method of making a transfer belt according to claim 2, wherein the coating liquid further comprises one or more additives selected from the group consisting of carbon black, carbon nanotubes, metal oxide, and polyaniline.

4. The method of making a transfer belt according to claim 1, wherein the step of curing the layer of coating to form a seamless belt comprises using one or more of thermal curing, uv curing, e-beam curing, oxidative curing, and epoxy curing.

5. The method of making a transfer belt according to claim 1 further comprising forming one or more additional layers of coating over the layer of coating.

6. The method of making a transfer belt according to claim 5, wherein the step of forming one or more additional layers of coating over the layer of coating comprises:
(a) dispensing a second coating liquid through the dispensing tip over the layer of coating;
(b) using the doctor blade to smooth the second coating liquid to produce a second layer of coating over the first layer of coating, such that the second layer of coating has a uniform thickness;
(c) curing the layer of coating; and
(d) repeating the steps a-c to form additional layers of coating.

7. The method of making a transfer belt according to claim 5, wherein the one or more additional layers differ from each other in at least one of material composition and thickness.

8. The method of making a transfer belt according to claim 1, wherein the step of providing a hollow mandrel comprises providing at least one of a rigid drum or a flexible belt.

9. The method of making a transfer belt according to claim 1 further comprises preparing the interior surface of the mandrel before the step of dispensing the coating liquid.

10. The method of making a transfer belt according to claim 8, wherein the step of preparing the interior surface of the mandrel comprises modifying the interior surface of the mandrel to a predetermined surface roughness in the range of about 100 nm to about 1 um.

11. The method of making a transfer belt according to claim 9, wherein the step of preparing the interior surface of the mandrel comprises applying a layer of releasing agent over the interior surface of the mandrel.

12. The method of making a transfer belt according to claim 1, wherein the step of releasing the belt from the interior surface of the mandrel comprises using one or more of solvent, surfactants, release agents, coating process, coating thickness, and difference in thermal expansion of the belt and the mandrel to release the belt from the mandrel.

13. The method of making a transfer belt according to claim 1, wherein the step of providing a hollow mandrel rotating about a longitudinal axis comprises providing a hollow mandrel rotating about a longitudinal axis at a surface speed in the range of about 1 millimeter/second to about 200 millimeter/second.

14. The method of making a transfer belt according to claim 1, wherein the step of dispensing a coating liquid through a dispensing tip over the interior surface of the rotating mandrel further comprises moving one or more of the dispensing tip and the mandrel along the longitudinal axis of the mandrel.

15. An apparatus for forming a seamless transfer belt comprising:
a hollow mandrel rotating about a longitudinal axis, the mandrel comprising an interior surface,
a dispensing tip disposed on an arm, the dispensing tip connected to a liquid reservoir; and
a doctor blade disposed adjacent to the dispensing tip,
wherein one or more of the dispensing tip and the hollow mandrel are moveable in one or more of x, y, and z direction.

16. The apparatus for forming a seamless transfer belt of claim 15, wherein the mandrel is disposed between a drive wheel and a plurality of rolling members, such that the mandrel is rotated by the drive wheel.

17. The apparatus for forming a seamless transfer belt of claim 15, wherein the mandrel is disposed over a plurality of rolling members and coupled to a drive motor via one or more of a drive belt and a coupling.

18. The apparatus for forming a seamless transfer belt of claim 15, wherein the dispensing tip comprises at least one of a nozzle, a die, and a needle.

19. The apparatus for forming a seamless transfer belt of claim 15, wherein the interior surface of the mandrel has a predetermined surface roughness in the range of about 100 nm to about 1 um.

20. The apparatus for forming a seamless transfer belt of claim 15, wherein the mandrel is configured to rotate at a surface speed in the range of about 1 millimeter/second to about 200 millimeter/second
